(19) United States
(12) Patent Application Publication
(10) Pub. No.: US 2007/0028231 A1
(43) Pub. Date: Feb. 1, 2007

(54) System and method for start menu and application uninstall synchronization

(75) Inventors: Scott Edwards Kelso, Durham, NC (US); John C. Mese, Cary, NC (US); Nathan J. Peterson, Raleigh, NC (US); Rod David Waltermann, Durham, NC (US); Arnold S. Weksler, Raleigh, NC (US)

Correspondence Address: VANLEEUWEN & VANLEEUWEN, P.O. BOX 90609, AUSTIN, TX, 78709-0609, US

(73) Assignee: International Business Machines Corporation, Armonk, NY (US)

(21) Appl. No.: 11/194,290

(22) Filed: Aug. 1, 2005

(51) Int. Cl. G06F 9/445

(52) U.S. Cl. 717/174

(57) ABSTRACT

A system and method is provided to track events related to shortcuts. These events include moving shortcuts from one location (menu) to another location (menu), renaming a folder in which a shortcut resides, and changing the name of a shortcut. Changes related to shortcuts generate operating system events. The system and method includes a process that is registered with the operating system in order to receive data regarding events that relate to shortcut changes. When a shortcut event is received by the process, the process updates applicable configuration files and references. Installation scripts are automatically updated so that the uninstall process (when eventually executed) can locate all shortcuts that pertain to the application and remove the shortcuts along with the uninstalled application.

### BACKGROUND OF THE INVENTION

1. Technical Field

The present invention relates in general to a method and system for improved cleanup of uninstalled software applications. More particularly, the present invention relates to a system and method that tracks events, such as move events, copy events, and rename events, so that all components can be removed when the application is uninstalled.

2. Description of the Related Art

Modern versions of Windows allow any user to create icons that are pointers to files, folders and other objects. These icons are “shortcuts” to the items they represent. Shortcuts are relatively simple to create, and there are many ways to create them. A simple way is by right-clicking on an object and dragging it with the right button held down a short distance. When the object is released, a menu pops up asking (among other things) if you want to create a shortcut.

Shortcuts can be placed on the desktop as well as folders and menus, such as the “Start Menu.” The Start Menu is actually a special folder that contains shortcuts.

Shortcuts can be used to navigate to an application, a folder or a drive. For example, if a user is frequently working within the My Documents folder, the user could create a shortcut to the user's favorite word processor and store the shortcut in the My Documents folder.

While shortcuts help improve productivity, they are not without challenges. When a shortcut to an application is moved from one location (i.e. folder) to another location, the uninstall process does not track the move. Therefore, when the application is uninstalled using the uninstall process, the shortcut is not removed along with the application. This results in “orphan” shortcuts residing in folders throughout the user's computer. When the user attempts to use one of these orphaned shortcuts, an error results because the underlying application has been uninstalled. This can cause confusion on part of the user who may not understand why the error is being reported.

### SUMMARY

It has been discovered that the aforementioned challenges are resolved using a system and method that tracks events related to shortcuts. These events include moving or copying shortcuts from one location (menu) to another location (menu), renaming a folder (menu) in which a shortcut resides, and changing the name of a shortcut.

Changes related to shortcuts generate operating system events. The system and method includes a process that is registered with the operating system in order to receive data regarding events that relate to shortcut changes. When a shortcut event is received by the process, the process updates applicable configuration files and references. Installation scripts are automatically updated so that the uninstall process (when eventually executed) can locate all shortcuts that pertain to the application and remove the shortcuts along with the uninstalled application.

In one embodiment, the process uses a dialog box to confirm the changes being made with the user. In this embodiment, the user is able to chose whether to allow the process to modify the application's uninstall data to reflect the shortcut changes, change the shortcut data back to the state before the change was made (i.e., move shortcut from one folder back to the original folder), and not change the application's uninstall data.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a menu depiction showing a shortcut being moved from the Start Menu to another menu, and the resulting Start Menu after the move event;

FIG. 2 is a menu depiction showing a shortcut being moved from the All Programs Menu to a sub-menu within the All Programs Menu, and the resulting All Programs Menu after the move event;

FIG. 3 is a flowchart showing the interaction between the operating system, the process that tracks shortcut events, and the uninstall process;

FIG. 4 is a flowchart of an enhanced process that receives user input regarding action to take when a shortcut event is identified; and

FIG. 5 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

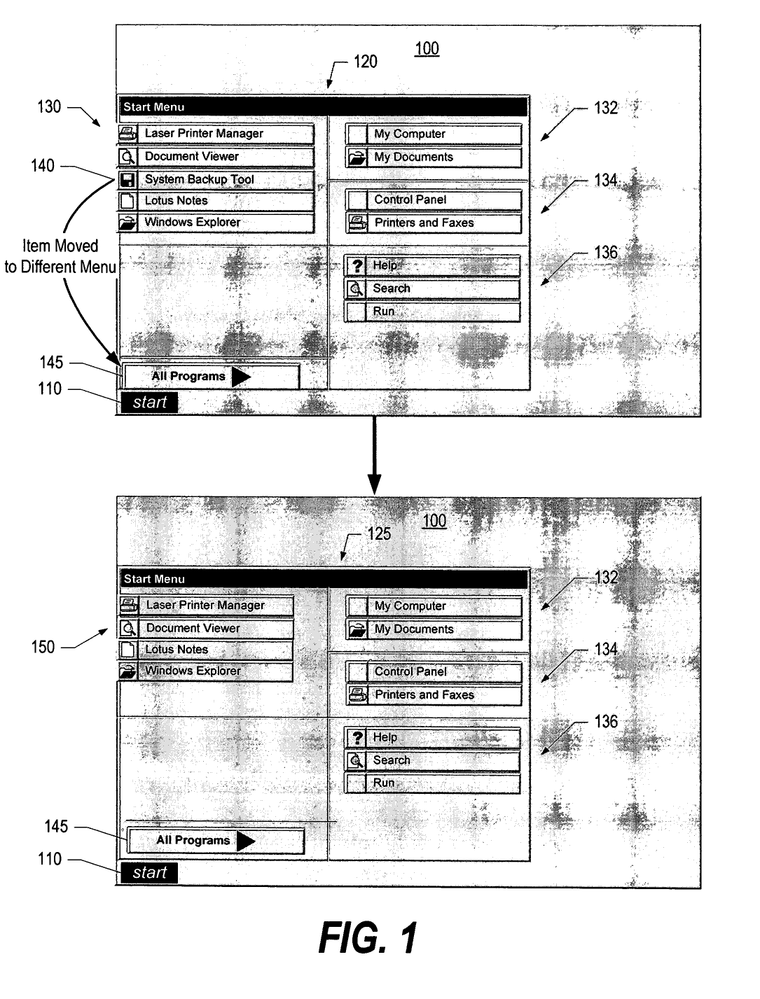

FIG. 1 is a menu depiction showing a shortcut being moved from the Start Menu to another menu, and the resulting Start Menu after the move event. Desktop 100 is the on-screen work area on which windows, icons, menus, and dialog boxes appear. One menu in Windows systems is “start menu” 120 that is launched by selecting start button icon 110. In many Windows systems, the start menu provides a quick way to perform many tasks common tasks, such as launching programs or using control panels. The start menu includes options for running programs, either by selecting an item (a shortcut) from the menu (that can be customized by the user), or by entering text in a dialog box (such as the “run” dialog). Start menu 120 shown in FIG. 1 is organized into programs menu 130, folders 132, control panels 134, and help/advanced functions 136. The All Programs menu is displayed listing additional programs, some of which do not appear in start menu 120, when the user selects All Programs button 145. Programs menu 130 includes one or more shortcuts that correspond to particular applications. In the example shown, shortcuts to applications titled “Laser Printer Manager,” “Document Viewer,” “System Backup Tool,” “Lotus Notes,” and “Windows Explorer” appear in programs menu 130.

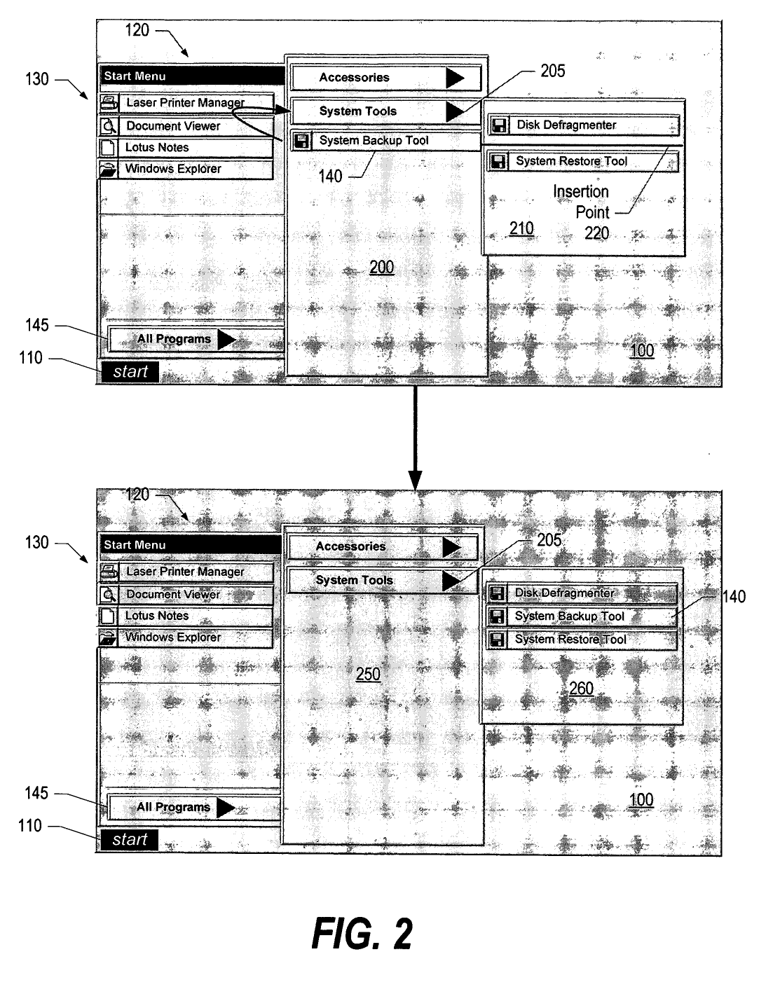

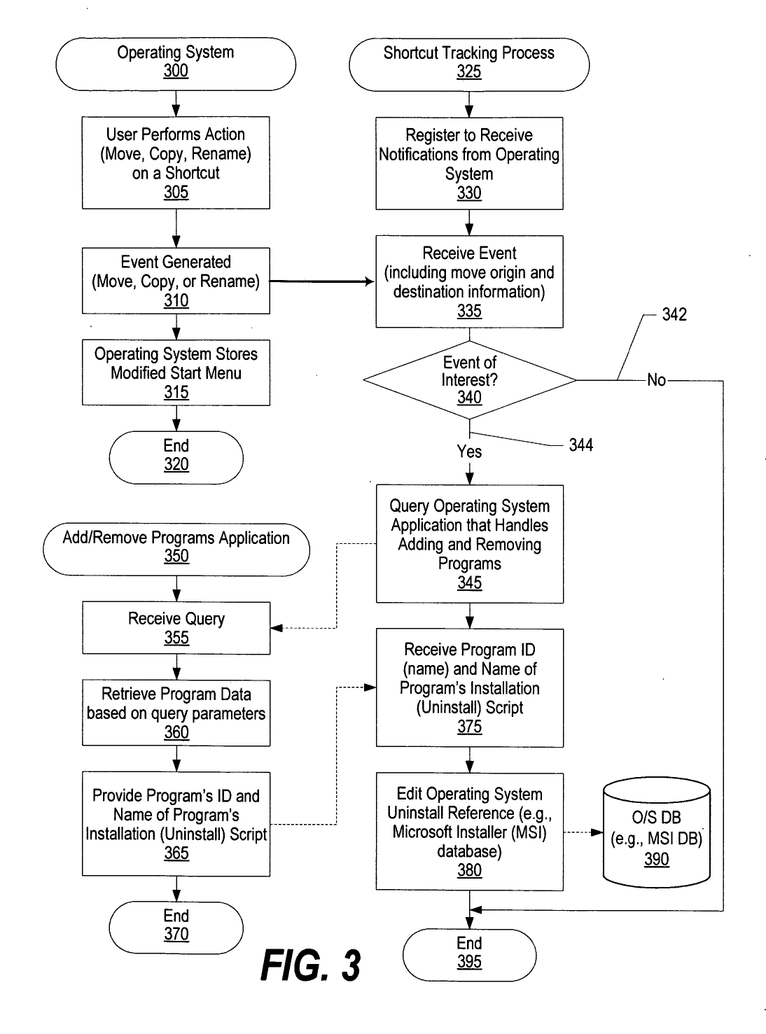

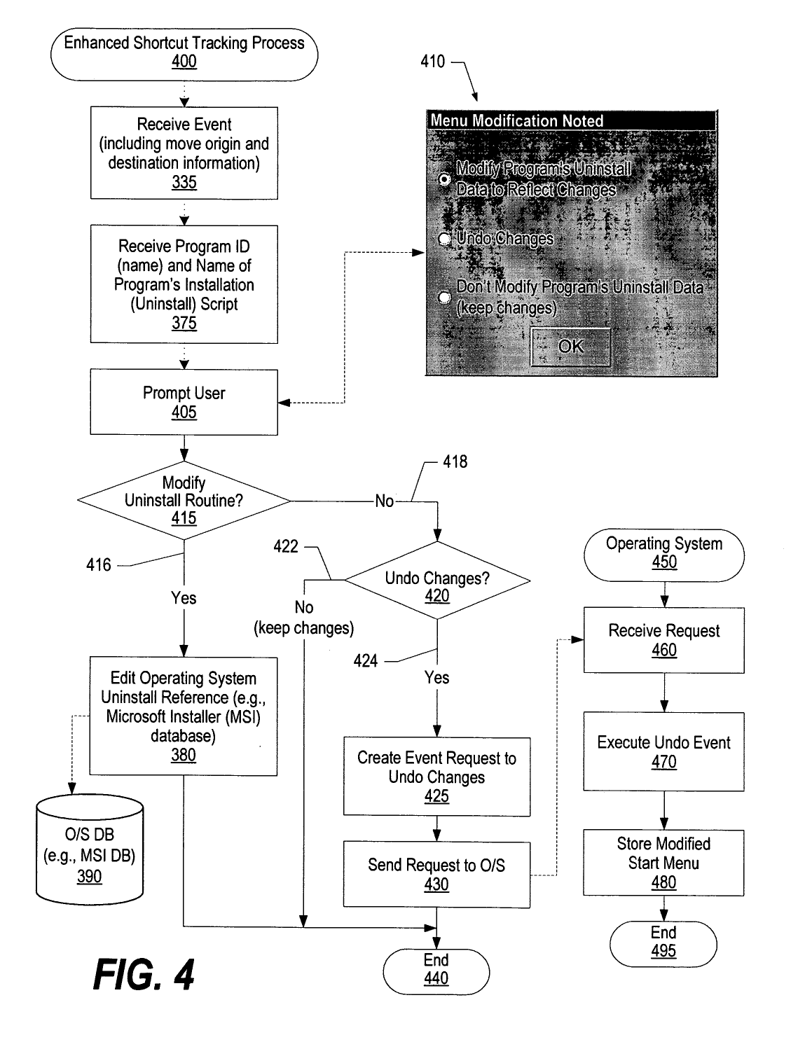

Also, in the example shown, one of the menu item shortcuts, System Backup Tool 140, is shown being moved to the All Programs menu by selecting the System Backup Tool shortcut icon 140 and dragging it to All Programs command button 145 whereupon a menu is displayed where many user-accessible programs are listed. A depiction of an All Programs menu is shown in FIG. 2. In one embodiment, shortcut icon 140 is “copied” to the All Programs menu and remains in menu 130 until it is deleted by the user. The copying of the shortcut to the All Programs menu and the deletion of the shortcut from programs menu 130 is tracked by a process and data about the events is recorded so that the shortcuts can be properly erased when the application (System Backup Tool) is eventually uninstalled. Details regarding this processing are shown in FIGS. 3 and 4. Resulting start menu 125 is shown with resulting programs menu 150 depicting how the programs menu looks after the shortcut (System Backup Tool 140) has been deleted.

FIG. 2 is a menu depiction showing a shortcut being moved from the All Programs Menu to a sub-menu within the All Programs Menu, and the resulting All Programs Menu after the move event. When the user selects All Programs command button 145 from start menu 120, All Programs Menu 200 is displayed. In the example shown, the All Programs Menu includes two submenus—an Accessories submenu and System Tools submenu 205. The All Programs Menu also includes System Backup Tool shortcut 140 that appeared in FIG. 1.

In the example shown in FIG. 2, the user selects System Backup Tool shortcut 140 and drags it to System Tools submenu 205. When the shortcut is dragged over submenu 205, submenu 210 appears and the user is able to move a horizontal line representing insertion point 220 within submenu 210. In the example shown, original System Tools menu 210 includes two shortcuts: a shortcut to a disk defragmenter and a shortcut to a system restore tool. In the example, the insertion point is placed between the two shortcuts. When the selector (e.g., mouse button) is released, shortcut 140 is moved to submenu 210.

Resulting menu 250 shows the All Programs Menu after the move has occurred. Note that shortcut 140 no longer appears on the All Programs Menu. Resulting submenu 260 shows the System Tools menu after the move event. Note that shortcut 140 now appears in the System Tools menu. The moving of the shortcut from the All Programs menu to the System Tools menu is tracked by a process and data about the event is recorded so that the shortcuts can be properly erased when the application (System Backup Tool) is eventually uninstalled. Details regarding this processing are shown in FIGS. 3 and 4.

FIG. 3 is a flowchart showing the interaction between the operating system, the process that tracks shortcut events, and the uninstall process. Depiction of the operating system process commences at 300 whereupon, at step 305, the user performs an action, such as renaming a shortcut in a menu, moving a shortcut from one menu to another menu, or copying a shortcut from one menu to another menu. The action performed by the user causes an operating system event to be generated at step 310. At step 315, the operating system stores the modified menu(s) reflecting the changes made to the menu(s) by the user. However, the operating system does not track the changes made to the shortcuts so that the moved/copied/renamed shortcuts can be removed when the underlying application corresponding to the shortcut is uninstalled. Instead, the operating system process ends at 320 and a separate process takes care of tracking the shortcut changes so that the uninstall process is able to remove all shortcuts when the application is uninstalled.

Processing of the separate process commences at 325. In one embodiment, the separate process that commences at 325 is a background process that waits for an event from the operating system. At step 330, the process registers with the operating system in order to receive notifications regarding particular events that are generated when a shortcut is moved, copied, or renamed. At step 335, the separate process receives the event from the operating system relating to the action performed on the shortcut. In one embodiment, the separate process receives the event because the process registered for the event at step 330. In another embodiment, where the operating system does not provide a means for registering for a particular event, the separate process listens to all the events occurring in the operating system but ignores all events except for the events relating to an action performed on a shortcut.

A determination is made as to whether the event is of interest (decision 340). If the operating system provides a means for registering for events relating to shortcuts, all such shortcut events may not be of interest. For example, if the user simply moves a shortcut within a particular menu (i.e., moves the shortcut either up or down in the “Start Menu”), then the event will not result in a need to track data so that the shortcut can be removed later (i.e., the shortcut is still in the same menu). If the event is not of interest, decision 340 branches to “no” branch 342 whereupon processing ends at 392. On the other hand, if the event is of interest because it will result in changes needed to the uninstall processing performed when the application is uninstalled, decision 340 branches to “yes” branch 344 to track the changes made related to the shortcut.

The operating system includes a program that is used to add or remove applications from the computer system. At step 345, this add/remove programs application is queried using data received from the shortcut, such as the name of the executable that corresponds to the shortcut that was moved/copied/renamed by the user. Add/remove programs application processing commences at 350 whereupon, at step 355, it receives the query from the separate process and, at step 360, it retrieves data relating to the program that corresponds to the shortcut. At step 365, data regarding the program is provided to the separate process in response to the query. This data includes, but is not limited to, the program's unique identifier and the name of the program's installation script that is used to uninstall the program. Add/remove programs application processing thereafter ends at 370.

Returning to the separate process, the separate process receives the data regarding the program, including the program's unique identifier and the name of the program's installation (uninstall) script at step 375. At step 380, the separate process edits the operating system's uninstall reference database 390. An example of an uninstall reference database is the Microsoft Installer (MSI) database used in operating systems provided by Microsoft Corporation. The script is edited based upon the change(s) related to the shortcut. For example, if a shortcut was moved from one menu to another, the process attempts to find a reference to the shortcut in the first menu, deletes the reference (if found), and creates a new reference to the shortcut in the new (second) menu. If a shortcut was copied from one menu to a second menu, then the database is updated with a new reference to the shortcut in the second menu. Finally, if a shortcut was renamed, the reference relating to the shortcut in the database is updated to reflect the shortcut's new name. Processing thereafter ends at 395.

FIG. 4 is a flowchart of an enhanced process that receives user input regarding action to take when a shortcut event is identified. Processing commences at 400 whereupon, as shown in more detail in the flowchart shown in FIG. 3, the process receives an event of interest at step 335 and receives data regarding the program that corresponds to the shortcut at step 375. In FIG. 4, however, rather than automatically updating the installer database, at step 405 the process prompts the user by displaying dialog box 410. Dialog box 410 includes three options with a radio-button control that the user use's to select one of the options. The user can either modify the program's uninstall data to reflect the changes made by the user (the move/copy/rename of the shortcut), undo the changes made to the shortcut, or keep the changes without updating the program's uninstall data. The user selects one of the three options and presses the “OK” command button.

A determination is made as to whether the user opted to modify the uninstall routine to reflect the changes made to the shortcut (decision 415). If the user opted to modify the uninstall routine, decision 415 branches to “yes” branch 416 whereupon, as shown in more detail in FIG. 3, the operating system's database used to store uninstall references (db 390) is updated at step 380.

Returning to decision 415, if the user did not opt to modify the uninstall routine, decision 415 branches to “no” branch 418 whereupon another determination is made as to whether the user opted to undo the changes made to the shortcut (decision 420). If the user did not opt to undo the changes and, instead, opted not to modify the program's uninstall data and to keep the changes (option 3), then decision 420 branches to “no” branch 422 bypassing the remaining steps and processing ends at 440. On the other hand, if the user did opt to undo the changes, decision 420 branches to “yes” branch 424 whereupon, at step 425, the separate process creates an event request to undo the changes made to the shortcut. If the event was to rename the shortcut, the process changes the name of the shortcut back to the original name. If the event was to move the shortcut to a different menu, the process creates an event to move the shortcut back to the original menu. Finally, if the event was to create a copy of the shortcut in a different menu, then the newly created shortcut (the copy) is removed from the menu onto which it was copied. At step 430, the created event is sent to the operating system to be performed and the process ends at 440. Operating system processing commences at 450 when, at step 460, the operating system receives the “undo” event request (a request/command to (a) move the shortcut back to the original menu (if a move event was performed), (b) erase a shortcut from a new location (if a copy event was performed), or (c) rename a shortcut back to the original name (if a rename event was performed). At step 470 the request/command to undo the shortcut action is performed. The operating system then performs housekeeping functions to store the modified menus with the moved/erased/renamed shortcut data at step 480. Operating system processing of the undo request then ends at 495.

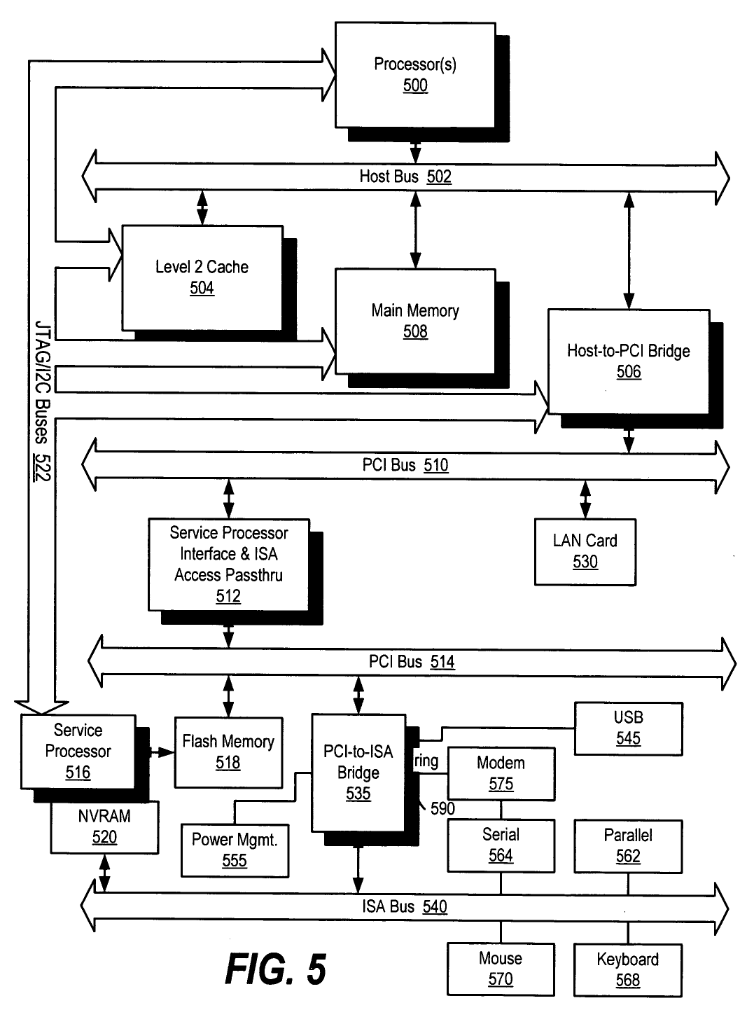

FIG. 5 illustrates information handling system 501 which is a simplified example of a computer system capable of performing the computing operations described herein. Computer system 501 includes processor 500 which is coupled to host bus 502. A level two (L2) cache memory 504 is also coupled to host bus 502. Host-to-PCI bridge 506 is coupled to main memory 508, includes cache memory and main memory control functions, and provides bus control to handle transfers among PCI bus 510, processor 500, L2 cache 504, main memory 508, and host bus 502. Main memory 508 is coupled to Host-to-PCI bridge 506 as well as host bus 502. Devices used solely by host processor(s) 500, such as LAN card 530, are coupled to PCI bus 510. Service Processor Interface and ISA Access Pass-through 512 provides an interface between PCI bus 510 and PCI bus 514. In this manner, PCI bus 514 is insulated from PCI bus 510. Devices, such as flash memory 518, are coupled to PCI bus 514. In one implementation, flash memory 518 includes BIOS code that incorporates the necessary processor executable code for a variety of low-level system functions and system boot functions.

PCI bus 514 provides an interface for a variety of devices that are shared by host processor(s) 500 and Service Processor 516 including, for example, flash memory 518. PCI-to-ISA bridge 535 provides bus control to handle transfers between PCI bus 514 and ISA bus 540, universal serial bus (USB) functionality 545, power management functionality 555, and can include other functional elements not shown, such as a real-time clock (RTC), DMA control, interrupt support, and system management bus support. Nonvolatile RAM 520 is attached to ISA Bus 540. Service Processor 516 includes JTAG and I2C busses 522 for communication with processor(s) 500 during initialization steps. JTAG/I2C busses 522 are also coupled to L2 cache 504, Host-to-PCI bridge 506, and main memory 508 providing a communications path between the processor, the Service Processor, the L2 cache, the Host-to-PCI bridge, and the main memory. Service Processor 516 also has access to system power resources for powering down information handling device 501.

Peripheral devices and input/output (I/O) devices can be attached to various interfaces (e.g., parallel interface 562, serial interface 564, keyboard interface 568, and mouse interface 570 coupled to ISA bus 540. Alternatively, many I/O devices can be accommodated by a super I/O controller (not shown) attached to ISA bus 540.

In order to attach computer system 501 to another computer system to copy files over a network, LAN card 530 is coupled to PCI bus 510. Similarly, to connect computer system 501 to an ISP to connect to the Internet using a telephone line connection, modem 575 is connected to serial port 564 and PCI-to-ISA Bridge 535.

While the computer system described in FIG. 5 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving an event generated by an operating system, the event responsive to an action performed on a shortcut in a menu, wherein the event is selected from the group consisting of a rename of the shortcut, a copy of the shortcut from the menu to a second menu, and a move of the shortcut from the menu to the second menu;
retrieving program data for an application program that corresponds to the shortcut; and
modifying uninstall reference data used by an uninstall program that uninstalls the application program, the modified data corresponding to the shortcut and relating to the event generated by the operating system so that the shortcut can be removed when the application program is uninstalled.

2. The method of claim 1 further comprising:
registering with the operating system prior to receiving the event, the registering including a request to receive event notifications regarding shortcut events.

3. The method of claim 1 further comprising:
querying uninstall reference data using shortcut data corresponding to the event; and
receiving program data corresponding to the application program in response to the querying.

4. The method of claim 3 further comprising:
locating the uninstall reference data using the received program data.

5. The method of claim 1 further comprising:
after receiving the event, but prior to modifying the uninstall reference data, displaying a dialog to a user with one or more selections;
receiving a selection from the user indicating that the user wishes to undo the event;
depending on the type of event, performing one of the following:
moving the shortcut back to the menu from the second menu in response to the event being the move of the shortcut;
removing the shortcut from the second menu in response to the event being the copy of the shortcut; and
renaming the shortcut from a new name to an original name in response to the event being the rename of the shortcut.

6. The method of claim 5 further comprising:
creating an undo event to perform the moving, removing, or renaming; and
requesting the execution of the undo event by the operating system.

7. The method of claim 1 further comprising:
selecting the event from a plurality of events, the selection based on matching one or more event types of interest with a plurality of event types included with the plurality of events.

8. A program product comprising:
a computer operable medium having computer readable code, the computer readable code being effective to:
receive an event generated by an operating system, the event responsive to an action performed on a shortcut in a menu, wherein the event is selected from the group consisting of a rename of the shortcut, a copy of the shortcut from the menu to a second menu, and a move of the shortcut from the menu to the second menu;
retrieve program data for an application program that corresponds to the shortcut; and
modify uninstall reference data used by an uninstall program that uninstalls the application program, the modified data corresponding to the shortcut and relating to the event generated by the operating system so that the shortcut can be removed when the application program is uninstalled.

9. The program product of claim 8 wherein the computer readable code is further effective to:
register with the operating system prior to receiving the event, the computer code used to register including computer code that requests to receive event notifications regarding shortcut events.

10. The program product of claim 8 wherein the computer readable code is further effective to:
query uninstall reference data using shortcut data corresponding to the event; and
receive program data corresponding to the application program in response to the querying.

11. The program product of claim 10 wherein the computer readable code is further effective to:
locate the uninstall reference data using the received program data.

12. The program product of claim 8 wherein the computer readable code is further effective to:
after receiving the event, but prior to modifying the uninstall reference data, display a dialog to a user with one or more selections;
receive a selection from the user indicating that the user wishes to undo the event;
depending on the type of event, execute computer readable code effective to perform one of the following:
move the shortcut back to the menu from the second menu in response to the event being the move of the shortcut;
remove the shortcut from the second menu in response to the event being the copy of the shortcut; and
rename the shortcut from a new name to an original name in response to the event being the rename of the shortcut.

13. The program product of claim 12 wherein the computer readable code is further effective to:
create an undo event to perform the move, remove, or rename; and
request the execution of the undo event by the operating system.

14. The program product of claim 8 wherein the computer readable code is further effective to:
select the event from a plurality of events, the selection based on matching one or more event types of interest with a plurality of event types included with the plurality of events.

15. An information handling system comprising:
one or more processors;
a memory accessible by the processors;
one or more nonvolatile storage devices accessible by the processors; and
a shortcut tracking tool for tracking events related to shortcuts, the shortcut tracking tool being effective to:
receive an event generated by an operating system, the event responsive to an action performed on a shortcut in a menu, wherein the event is selected from the group consisting of a rename of the shortcut, a copy of the shortcut from the menu to a second menu, and a move of the shortcut from the menu to the second menu;
retrieve program data for an application program that corresponds to the shortcut; and
modify uninstall reference data stored on one of the nonvolatile storage devices, the uninstall reference data used by an uninstall program that uninstalls the application program, the modified data corresponding to the shortcut and relating to the event generated by the operating system so that the shortcut can be removed when the application program is uninstalled.

16. The information handling system of claim 15 wherein the shortcut tracking tool is further effective to:
register with the operating system prior to receiving the event, the computer code used to register including computer code that requests to receive event notifications regarding shortcut events.

17. The information handling system of claim 15 wherein the shortcut tracking tool is further effective to:
query uninstall reference data using shortcut data corresponding to the event; and
receive program data corresponding to the application program in response to the querying.

18. The information handling system of claim 10 wherein the shortcut tracking tool is further effective to:
locate the uninstall reference data using the received program data.

19. The information handling system of claim 15 wherein the shortcut tracking tool is further effective to:
after receiving the event, but prior to modifying the uninstall reference data, display a dialog to a user with one or more selections;
receive a selection from the user indicating that the user wishes to undo the event;
depending on the type of event, perform one of the following:
move the shortcut back to the menu from the second menu in response to the event being the move of the shortcut;
remove the shortcut from the second menu in response to the event being the copy of the shortcut; and
rename the shortcut from a new name to an original name in response to the event being the rename of the shortcut.

20. The information handling system of claim 12 wherein the shortcut tracking tool is further effective to:
create an undo event to perform the move, remove, or rename; and request the execution of the undo event by the operating system.
